(19) United States
(12) Patent Application Publication
(10) Pub. No.: US 2017/0262456 A1
(43) Pub. Date: Sep. 14, 2017

(54) FILE MANAGEMENT APPARATUS, FILE MANAGEMENT METHOD AND NON-TRANSITORY COMPUTER READABLE MEDIUM STORING PROGRAM

(71) Applicant: FUJI XEROX CO., LTD., Tokyo (JP)

(72) Inventors: Ken ICHIKAWA, Yokohama-shi (JP); Kiyoshi TASHIRO, Yokohama-shi (JP); Yasuhiro ITO, Yokohama-shi (JP); Toshiharu YOKOYAMA, Yokohama-shi (JP); Tomoyuki SHIMIZU, Yokohama-shi (JP)

(73) Assignee: FUJI XEROX CO., LTD., Tokyo (JP)

(21) Appl. No.: 15/218,493

(22) Filed: Jul. 25, 2016

(30) Foreign Application Priority Data
Mar. 11, 2016 (JP) 2016-048007

(51) Int. Cl. G06F 17/30

(52) U.S. Cl. CPC G06F 17/30082; G06F 17/30129; G06F 17/30091

(57) ABSTRACT

A file management apparatus includes a file importance calculating unit that calculates a importance of each file stored in a storage region, a storage region importance calculating unit that calculates the importance of the storage region, based on the importance of each file calculated by the file importance calculating unit, and a file managing unit that performs file management with respect to the file based on the importance of the storage region designated as a storage destination of the file.

### CROSS-REFERENCE TO RELATED APPLICATIONS

This application is based on and claims priority under 35 U.S.C. 119 from Japanese Patent Application No. 2016-048007 filed on Mar. 11, 2016.

### TECHNICAL FIELD

The present invention relates to a file management apparatus, a file management method and a non-transitory computer readable medium storing a program.

### SUMMARY

According to an aspect of the present invention, a file management apparatus includes a file importance calculating unit that calculates a importance of each file stored in a storage region, a storage region importance calculating unit that calculates the importance of the storage region, based on the importance of each file calculated by the file importance calculating unit, and a file managing unit that performs file management with respect to the file based on the importance of the storage region designated as a storage destination of the file.

### BRIEF DESCRIPTION OF THE DRAWINGS

Exemplary embodiments of the present invention will be described in detail based on the following figures, wherein:

FIG. 1 is a block configuration drawing showing a document management apparatus that is one exemplary embodiment of a file management apparatus according to a present invention;

FIG. 2 is a hardware configuration drawing of a server computer that forms the document management apparatus in an exemplary embodiment 1;

FIG. 3 is a drawing used to illustrate a calculating method of document importance in the exemplary embodiment 1;

FIG. 4 is a flow chart showing document processing in the exemplary embodiment 1; and

FIG. 5 is a block configuration drawing of the document management apparatus in an exemplary embodiment 3.

### DETAILED DESCRIPTION

Hereinafter, exemplary embodiments according to a present invention will be described with reference to drawings.

### Exemplary Embodiment 1

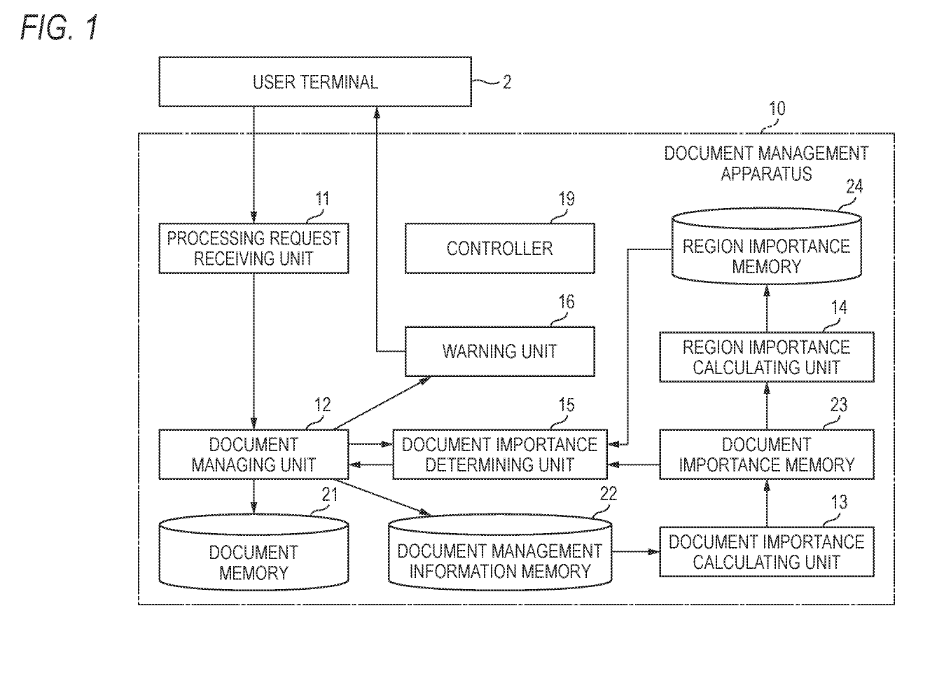

FIG. 1 is a block configuration drawing showing a document management apparatus 10 that is one exemplary embodiment of a file management apparatus according to the present invention. In the present exemplary embodiment, a case of handling an electronic document (hereinafter, simply referred to as “document”) as one form of a file will be described as an example. The document management apparatus 10 and a user terminal 2 in the present exemplary embodiment are shown in FIG. 1.

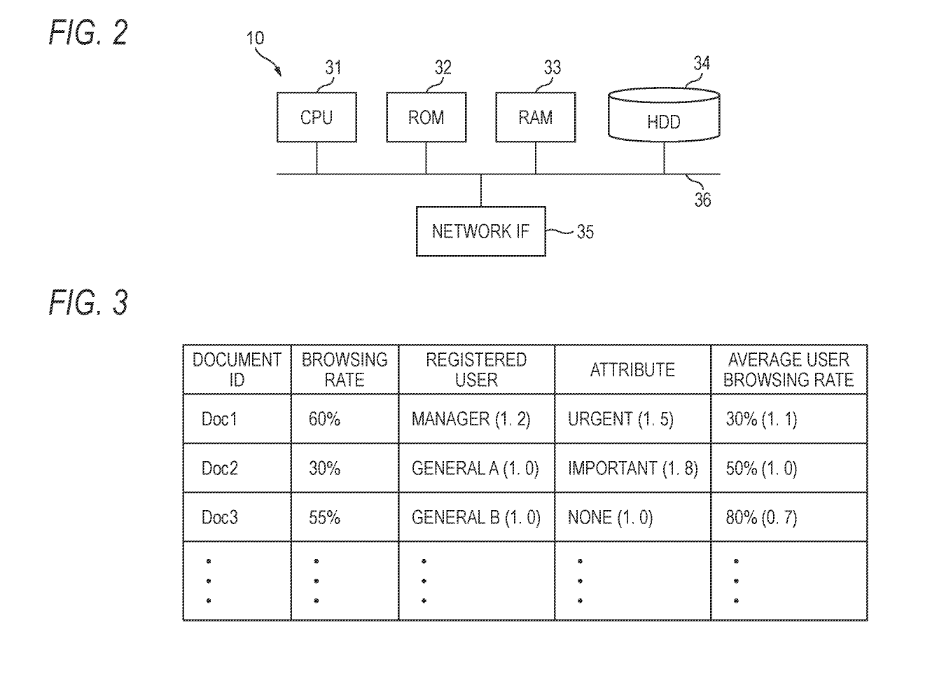

FIG. 2 is a hardware configuration drawing of a server computer that forms the document management apparatus 10 in the present exemplary embodiment. The server computer that forms the document management apparatus 10 in the present exemplary embodiment may be realized by a general-purpose hardware configuration in the related art. That is, a computer is configured to connect a CPU 31, a ROM 32, a RAM 33, a hard disk drive (HDD) 34, and a network controller 35 which is provided as a communication unit to the internal bus 36, as shown in FIG. 2. Although an input/output unit such as a mouse, a keyboard or a display is not required in the present exemplary embodiment, it may be configured to include the computer.

Returning to FIG. 1, the document management apparatus 10 according to the present exemplary embodiment includes a processing request receiving unit 11, a document managing unit 12, a document importance calculating unit 13, a region importance calculating unit 14, a document importance determining unit 15, a warning unit 16, a controller 19, a document memory 21, a document management information memory 22, a document importance memory 23, and a region importance memory 24. The processing request receiving unit 11 receives a processing request for the document sent from the user terminal 2. As the processing request, for example, there is overwriting storage, movement between folders, or the like. The document managing unit 12 performs document management, such as executing the instructed processing for the document in response to the processing request received from the processing request receiving unit 11. In particular, the document managing unit 12 performs the document management, based on a document importance and a region importance in the present exemplary embodiment. The document importance calculating unit 13 calculates a importance of each document, based on the document management information for each document registered in the document management information memory 22, and writes and stores the importance in the document importance memory 23. The region importance calculating unit 14 calculates the importance of a storage region of the document, based on the document importance registered in the document importance memory 23 and writes and stores the importance in the region importance memory 24. The present exemplary embodiment calculates the importance of the entire document memory 21, that is, the hard disk drive 34 as the storage region of the document. The processing request is received by the processing request receiving unit 11, and the document importance determining unit 15 determines the document importance that is the subject of document management by the document managing unit 12. In a case where the document managing unit 12 refers to a determination result by the document importance determining unit 15, and determines that the processing request received by the processing request receiving unit 11, in other words, the processing requested by the user may not be processed from a viewpoint of the importance, the warning unit 16 notifies a warning to the user terminal 2 of a processing requester, that is, to the user who requests the processing. The controller 19, in cooperation with each component 11 to 16, entirely performs control of the document management in the present exemplary embodiment.

The entity of the document of the document management target is accumulated in the document memory 21. The management information (document management information) relating to each document stored in the document memory 21 is accumulated in the document management information memory 22. The document management information includes the information relating to the document of an IP address or a browsing history of the terminal that requests the processing for the document, in addition to attribute information of the document of a document ID of the document, a creation date, an update date, the number of pages, and the like. Furthermore, the attribute information of the document owner, such as a user ID, an affiliation, and a position (job title) of a document owner is also included.

The importance of each document calculated by the document importance calculating unit 13 is stored in correlation with the document ID of the document in the document importance memory 23. The importance of the storage region calculated by the region importance calculating unit 14 is stored in correlation with a region ID of the storage region in the region importance memory 24.

Each of the components 11 to 16 and 19 in the document management apparatus 10 is realized by the cooperative operation of the computer that forms the document management apparatus 10 and a program that operates by a CPU 31 mounted on the computer. Each memory 21 to 24 is realized by an HDD 34 mounted on the document management apparatus 10. Alternatively, each memory may use a RAM 33 or an external storage unit via a network.

The program used in the present exemplary embodiment is provided by the communication unit as a matter of course, and may be provided by storing the program in a computer-readable recording medium such as a CD-ROM or a USB memory. The program provided from the communication unit or the recording medium is installed in the computer. Various processing is realized by the CPU of the computer sequentially executing the program.

Next, an operation in the present exemplary embodiment will be described.

When the document is newly created, the document managing unit 12 registers the document in the document memory 21, and creates the document management information to register in the document management information memory 22. When the management target document is browsed, the document managing unit 12 additionally registers browsing information including a browsing date and time, the user or the like to the document management information of the document as the browsing history. The document management apparatus 10 manages the document as described above. The document management such as a registration, the browsing history, or deletion of the document as described above may basically be the same as before, except for the characteristic processing that will be described below.

Furthermore, in the present exemplary embodiment when the document management information registered in the document management information memory 22 is updated, the document importance calculating unit 13 calculates the document importance to update the importance by overwriting storage in the document importance memory 23. The document importance is calculated as described below.

FIG. 3 is a drawing shown in a table format by partially extracting the document management information of each document stored in the document memory 21. In the present exemplary embodiment, the importance is calculated by digitalizing each value of the attribute information of each document to substitute the value into a predetermined calculation formula. In FIG. 3, a numerical value shown in parentheses is the numerical value that indicates the importance of each attribute value. For example, the value indicates the document importance of which a registered user (document owner) is a manager is higher than that of the document which a general staff member creates. Accordingly, when this value is substituted into the calculation formula, the importance of the document the manager creates is relatively higher than that of the document the general staff member creates.

A browsing rate is calculated by a formula such as the number of browsing persons/the number of users capable of browsing, by referring to the browsing history of document management information. Since being browsed at a higher rate when the browsing rate is high, the document of which the browsing rate is high may be said to be a relatively high importance document. However, when the number of users capable of browsing is small, it is likely to indicate a high numerical value of the browsing rate. Therefore, it is suitable to cope with the browsing rate by multiplying the appropriate weight according to the value of the number of users capable of browsing.

Although the browsing rate for the user (user browsing rate) may be calculated by the formula such as the number of browsing documents/the number of the documents the user may browse, the document that the user of the low browsing rate browses is estimated to have the importance that is high. Therefore, the importance of each document is calculated by determining the average of the user browsing rate of the user who browses each document.

In this manner, although “importance” is the index which objectively indicates the document importance, the method of calculating the importance is not limited to the above calculation method, and may use other data items of the document management information or may adapt another formula.

In the present exemplary embodiment, although it is assumed that the document importance of the document is updated at the timing when the document is updated, the update timing is not necessarily limited to this, and the document importance may be updated by scheduled processing.

When any of the document priorities registered in the document importance memory 23 is updated, the region importance calculating unit 14 calculates the importance of the storage region of the document, based on the document importance registered in the document importance memory 23 and writes and stores the importance in the region importance memory 24. In the present exemplary embodiment, for example, all of the average values of the document priorities are calculated as the region importance of the document memory 21 (storage region), based on all of the document priorities registered in the document importance memory 23. The region importance may also be updated by the scheduled processing.

In the present exemplary embodiment, even in a case where the processing request receiving unit 11 does not receive the processing request, the above processing is normally executed. As is evident from this description, a new registration and the browsing of the document to the document memory 21 is not included in the processing target that the processing request receiving unit 11 receives.

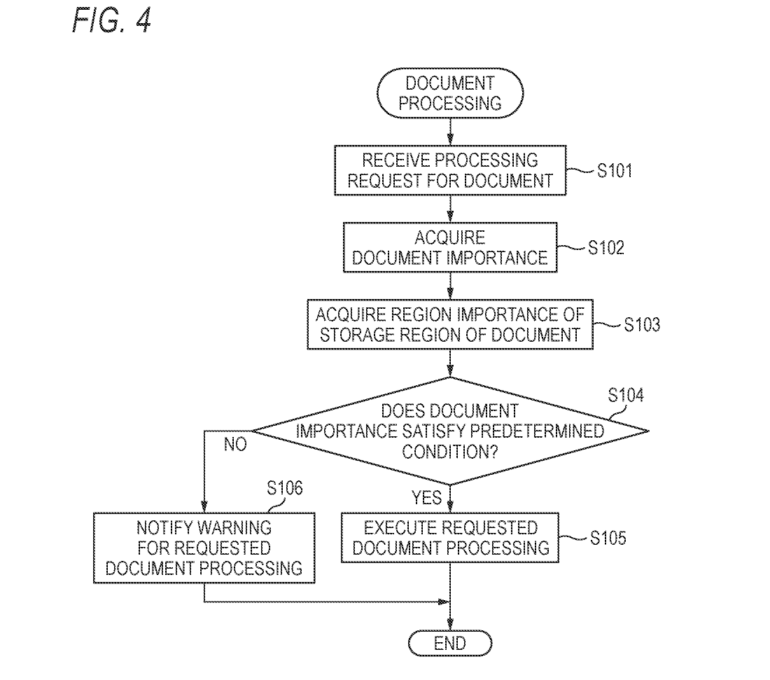

Hereinafter, the document processing to be executed in a case where the document processing from the user is requested in the present exemplary embodiment will be described with reference to a flowchart shown in FIG. 4. In the present exemplary embodiment, a case where an overwriting storage request of the document is sent from the user terminal 2 will be described as an example.

The user uses the user terminal 2 to edit the document stored in the document memory 21, and performs a predetermined operation for the overwriting storage. When the overwriting storage request of the document is sent from the user terminal 2 in response to the operation, the processing request receiving unit 11 receives the processing request thereof (Step 101). At this point in time, the overwriting storage is not executed.

In a case where the processing request that the processing request receiving unit 11 receives is the overwriting storage, the document managing unit 12 inquires about a level of the document importance by passing the document ID of the processing target document to the document importance determining unit 15. When the document importance determining unit 15 receives the document ID at the time of the inquiry from the document managing unit 12, the document importance determining unit 15, retrieves and acquires the document importance of the document from the document importance memory 23 (Step 102). Furthermore, the document importance determining unit 15 retrieves and acquires the region importance from the region importance memory 24 (Step 103).

When the document importance determining unit 15 receives each importance, the document importance determining unit 15 determines whether the document importance satisfies a condition relating to the set importance or not, based on the importance of the storage region designated as a storage destination of the document. In the present exemplary embodiment, due to the overwriting storage request of the document, the storage region designated as the storage destination of the document by the user, is the storage region where the document is currently stored, and the document memory 21 (hard disk drive 34) in a case of the present exemplary embodiment. As the condition relating to the importance, an allowable range of the document importance is set. The allowable range is set, for example, at ±30% from the region importance. For example, when the region importance is 70, 70×30%=21. Therefore, the importance of 49 to 91 is equivalent to the allowable range. That is, the document of the document importance 49 to 91 is determined as the document of the importance to be normally stored in the document memory 21. Accordingly, the document of more than 91 is determined to be the document of the high importance, and the document of less than 49 is determined to be the document of the low importance.

Additionally, although the document importance determining unit 15 determines the document importance in response to the processing request of the overwriting storage, the overwritten and stored document is in a state of already being stored in the document memory 21. In a case where the overwritten and stored document is determined to the high importance, important information may actually be included in the document thereof, because the browsing rate is high or the document is created by the user of a high position. The important information may be deleted by editing by the user. In a case where the important information is deleted by the editing, when an existing document is overwritten by the edited document (document that is not stored yet), important information is lost. Therefore, the overwriting storage is considered to be avoided in this case. Therefore, in the present exemplary embodiment, the document importance requiring the overwriting storage is determined.

The document importance determining unit 15 returns an above processing result, that is, whether the document requiring the overwriting storage is the document of the high importance or the low importance, or a normal importance included in the allowable range, to the document managing unit 12 that inquires as a determination result.

The document managing unit 12 refers to the determination result by the document importance determining unit 15, when the document of the overwriting storage target is the document of the normal importance (Y in Step 104), and performs the overwriting storage as requested by the user (Step 105). On the other hand, when the document of the overwriting storage target is the document of the high importance (N in Step 104), the document managing unit 12 instructs the warning unit 16 to warn. The warning unit 16 notifies a warning to this effect to the user terminal 2 (user who needs the overwriting storage) which is sent the overwriting storage request in response to an instruction (Step 106).

When the document of the overwriting storage target is the document of the low importance (N in Step 104), the warning is notified to the user as the warning similar to the document of the high importance. Since the document is not a document of the high importance, the document may be handled similar to the document of the normal importance.

In the present exemplary embodiment, although the description is stopped by notifying the warning to the user who needs the overwriting storage to the document of the high importance, the overwriting storage may be prohibited in addition to the warning for the overwriting storage request. When the user receiving the warning still requests the overwriting storage, the repeated request thereof may be accepted.

According to the present exemplary embodiment, as described above, in a case where the document of the high importance needs to be overwritten and stored, the warning is notified to the user who needs the overwriting storage. Thus, in a case where the important information is included in the stored document, it is possible to prevent deletion of the information in advance.

In the present exemplary embodiment, although the overwriting storage is described as an example, the above-described document processing for the deletion request of the document may be applied.

In the present exemplary embodiment, although it is described that the document importance and the region importance is calculated in advance, the document importance and the region importance may be calculated at the timing of receiving the request of the overwriting storage. That is, the document importance may be calculated at the time of the processing (Step 102) to acquire the document importance, and the region importance may be calculated at the time of the processing (Step 103) to acquire the region importance.

### Exemplary Embodiment 2

In the above-described exemplary embodiment 1, the document management of a case of the document requiring the overwriting storage is described. In the present exemplary embodiment, the document management of a case of the document requiring movement/copying will be described. The movement will be described as an example in the description hereinafter. In the above-described exemplary embodiment 1, all of the documents stored in the document memory 21 that is the storage region are a calculation target of the region importance. Accordingly, even when the document of the overwriting storage target is stored in any folder, the calculation result of the region importance is the same. In a case of the present exemplary embodiment, the folder that is a movement destination of the existing document is the storage region. That is, the region importance is calculated for each folder.

Although a block configuration and a hardware configuration of the document management apparatus 10 in the present exemplary embodiment may be the same as the exemplary embodiment 1, and the flow itself of the document processing shown in FIG. 4 may be the same as the exemplary embodiment 1, since a calculation unit of the storage region is different, a predetermined condition used in Step 103 and Step 104 is different from the exemplary embodiment 1. Hereinafter, the document processing in the present exemplary embodiment will be described. Although a calculation method of the document importance and the region importance in a normal operation may be the same as the exemplary embodiment 1, as described above, it is different from the exemplary embodiment 1 in which the region importance is calculated for each folder created in the document memory 21, rather than the entire document memory 21. Accordingly, the region importance of each folder may be acquired by calculating the average value of the document priorities stored in the folder.

The user performs a predetermined operation such as a drag and drop so as to move a document stored in the document memory 21. When the movement request of the document from the user terminal 2 in response to this operation is sent, the processing request receiving unit 11 receives the processing request (Step 101).

In a case where the processing request that the processing request receiving unit 11 receives is the movement, the document managing unit 12 inquires about the level of the document importance by passing the information that identifies the folder that is a movement destination such as the document ID and the folder name of the document of the processing target to the document importance determining unit 15. The document importance determining unit 15 acquires the document importance of the document (Step 102), based on the document ID received at the time of the inquiry from the document managing unit 12 and acquires the region importance of the folder (Step 103) based on the folder name received.

Subsequently, when the document importance determining unit 15 acquires each importance, the document importance determining unit 15 determines whether the document importance of the movement target document satisfies the condition relating to the set importance or not, based on the importance of the folder designated as the storage destination (movement destination) of the document. The allowable range of the importance is set as the condition relating to the importance, based on the region importance of the folder of the movement destination. Although the allowable range may be set at ±30% from the region importance similar to the exemplary embodiment 1, a difference between the document importance and the region importance is compared with a threshold set in advance in the present exemplary embodiment. That is, when the difference is within the threshold, the document importance determining unit 15 determines that the movement target document is the document of the importance to be normally stored in the folder of the movement destination.

Additionally, the document is normally classified based on any document attribute and stored in the folder. In other words, the same type of document is considered to be stored in the same folder. When the document is moved to the designated folder, the document is considered to be collected in the same type of document in the folder of the movement destination. Since the region importance of the folder is calculated by the average value of the document priorities of the documents stored in the folder, in a case where the document importance is a determination index of the same type of document, the document in which the document importance is significantly deviated from this region importance (document in which the difference exceeds the threshold) is also considered not to be the same type of document. Accordingly, in the present exemplary embodiment, when the difference between the document importance of the movement target document and the region importance of the folder of the movement destination exceeds the threshold, it is determined that the movement target document is not the same type of document as the document stored in the folder of the movement destination. On the other hand, when the difference is within the threshold, it is determined that the movement target document is the same type of document as the document stored in the folder of the movement destination.

The document importance determining unit 15 returns the above processing result, that is, whether the document requiring the movement is significantly deviated from the region importance of the folder of the movement destination, or the same type of document as the document stored in the folder of the movement destination, to the document managing unit 12 that inquires as a determination result.

The document managing unit 12 refers to the determination result by the document importance determining unit 15, when the difference between the document importance of the movement target document and the region importance of the folder of the movement destination is within the threshold (Y in Step 104), and performs the movement of the document as requested by the user (Step 105). On the other hand, when the difference exceeds the threshold (N in Step 104), the document managing unit 12 causes the warning unit 16 to notify a warning to this effect to the user terminal 2 (user who needs the movement) which sent the movement request (Step 106).

According to the present exemplary embodiment, as described above, in a case where the document needs to be moved to the folder in which the different document is stored, the warning is notified to the user who needs to move the document. Thus, it is possible to prevent the movement to the folder in which the different document is stored in advance.

In the present exemplary embodiment, although the movement is described as an example, the processing for the copy request of the document may be applied.

### Exemplary Embodiment 3

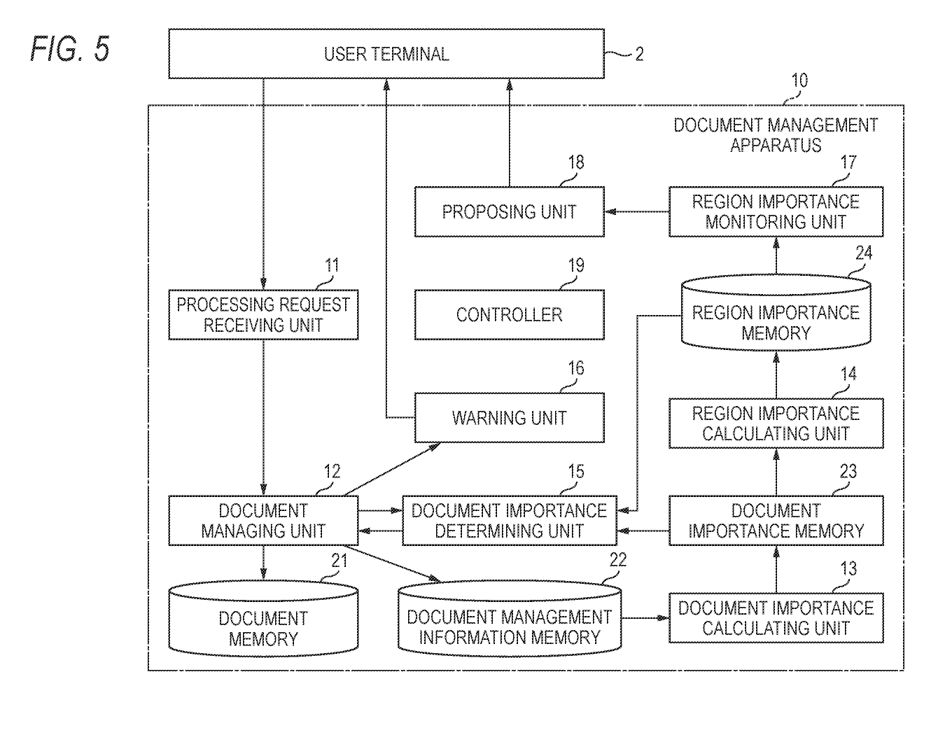

FIG. 5 is a block configuration drawing of the document management apparatus 10 in the present exemplary embodiment. In FIG. 5, the same reference numerals refer to the same components as in FIG. 1, and the description will appropriately be omitted. The document management apparatus 10 in the present exemplary embodiment includes a configuration obtained by adding a region importance monitoring unit 17 and a proposing unit 18 to a configuration shown in the exemplary embodiment 1. A hardware configuration of the document management apparatus 10 in the present exemplary embodiment may be the same as the exemplary embodiment 1. The region importance monitoring unit 17 normally monitors the region importance calculated by the region importance calculating unit 14 and stored in the region importance memory 24. The proposing unit 18 receives a monitoring result by the region importance monitoring unit 17, in a case where the region importance no longer satisfies the condition relating to the importance set in advance, and presents the information relating to access control management of the folder. The region importance monitoring unit 17 and the proposing unit 18 are realized by a cooperative operation of the computer forming the document management apparatus 10 and the CPU 31 mounted in the computer.

The operation in the document management apparatus 10 of the present exemplary embodiment is different from the exemplary embodiment 1 and 2 in which the document processing is started after the processing request receiving unit 11 receives the processing request. That is, although the region importance monitoring unit 17 normally monitors the value of the region importance set in the region importance memory 24, when it is detected that the region importance no longer satisfies the condition relating to the importance, the region importance monitoring unit 17 notifies this effect to the proposing unit 18. The proposing unit 18 receives the notification and sends a message to perform the access control management such as setting a desired access right to the folder that no longer satisfies the condition relating to the importance, to the user terminal 2, strictly to a folder owner or to a manager of the document memory 21. As a method of notifying the message, for example, when an e-mail address of the user may be referred to, the message is notified by e-mail to the recipient. Specific contents of the message is such as a limitation setting to the user capable of browsing.

Although the region importance is determined by the document importance of the document to be stored, the browsing rate is increased by the document being browsed by the user. The case may be assumed in which the document importance is increased in accordance with this. When the document importance is increased and the region importance is increased in accordance with this, the access control management may be executed from a viewpoint of a security, or it may be considered to review the management such as setting the set access level high. Accordingly, in the present exemplary embodiment, the threshold is set as a determination criterion of whether the access control management is performed or not (condition relating to the importance). In a case where the region importance exceeds the threshold, the access control management is proposed to the user to perform the access control management.

Hereinbefore, although the document management is described in each exemplary embodiment based on the index of the region importance obtained based on the document importance, each above-described exemplary embodiment may be executed in an appropriate combination.

In the present exemplary embodiment, for simplicity of the description, although it is described so as to realize the characteristic document management by one document management apparatus 10 in the present exemplary embodiment, the document management need not be limited to this configuration. For example, a memory unit (document memory 21 and document management information memory 22) of the information relating to the document may be realized in a cloud or a network attached storage (NAS) may be network-connected. The document management apparatus 10 may be configured with plural computers, such as a component to realize a function to add to the document management apparatus of the related art, for example, the document importance calculating unit 13, the region importance calculating unit 14, and the document importance determining unit 15 may be configured with a different computer from the existing document management apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A file management apparatus comprising:
a file importance calculating unit that calculates a importance of each file stored in a storage region;
a storage region importance calculating unit that calculates the importance of the storage region, based on the importance of each file calculated by the file importance calculating unit; and
a file managing unit that performs file management with respect to the file based on the importance of the storage region designated as a storage destination of the file.

2. The file management apparatus according to claim 1, further comprising:
a notifying unit that notifies a warning to a requester without storing the file, in a case where the importance of the file of a file management target does not satisfy a condition relating to the importance set, based on the importance of the storage region designated as a storage destination of the file.

3. The file management apparatus according to claim 2, wherein the storage destination of the file is designated by an overwriting storage operation by a user.

4. The file management apparatus according to claim 2, wherein the storage destination of the file is designated by movement or a copy operation of the file by the user.

5. The file management apparatus according to claim 1, further comprising:
a presenting unit that presents information relating to access control management of the storage region, in a case where the importance of the storage region that is calculated by the storage region importance calculating unit no longer satisfies the condition relating to the importance set in advance.

6. A file management method comprising:
calculating a importance of each file stored in a storage region;
calculating the importance of the storage region, based on the importance of each calculated file; and
performing file management with respect to the file based on the importance of the storage region designated as a storage destination of the file.

7. A non-transitory computer readable medium storing a program causing a computer to execute a function, the function comprising:
calculating a importance of each file stored in a storage region as a file importance calculating unit;
calculating the importance of the storage region, based on the importance of each file calculated by a file importance calculating unit as a storage region importance calculating unit; and
performing file management with respect to the file based on the importance of the storage region designated as a storage destination of the file as a file managing unit.
